(19) United States
(12) Patent Application Publication
(10) Pub. No.: US 2016/0061712 A1
(43) Pub. Date: Mar. 3, 2016

(54) METHOD AND APPARATUS FOR MONITORING BIOFOULING ACTIVITY

(71) Applicant: H2O, INC., LAFAYETTE, LA (US)

(72) Inventors: JESS E. FIKE, LAFAYETTE, LA (US); IAN F.E. PERRETT, LAFAYETTE, LA (US); HARRY J. POLMAN, LAFAYETTE, LA (US); DARYL J. MARSE, LAFAYETTE, LA (US)

(21) Appl. No.: 14/839,930

(22) Filed: Aug. 29, 2015

Related U.S. Application Data
(60) Provisional application No. 62/043,548, filed on Aug. 29, 2014.

(51) Int. Cl. G01N 17/00

(52) U.S. Cl. CPC G01N 17/008

(57) ABSTRACT

A method and apparatus for use in monitoring biofouling activity by determining a variety of different velocity rates of fluid via a biofouling monitor assembly. The biofouling monitor assembly beneficially provides a significant means for monitoring biofilm activity of macroscopic organisms and microscopic organisms across a variety of substrates or surfaces within an internal monitoring assembly of the present invention.

### CROSS REFERENCES TO RELATED APPLICATION

Priority of U.S. Provisional Patent Application Ser. No. 62/043,548, filed Aug. 29, 2014, incorporated herein by reference, is hereby claimed.

### STATEMENTS AS TO THE RIGHTS TO THE INVENTION MADE UNDER FEDERALLY SPONSORED RESEARCH AND DEVELOPMENT

None

### BACKGROUND OF THE INVENTION

1. Field of the Invention

The present invention pertains to a method and apparatus for measuring macroscopic and microscopic fouling on a variety of different materials at different flow rates and different media velocities. More particularly, the present invention pertains to a biofouling monitor assembly for use in monitoring biofilm activity of macroorganisms and microorganisms on a variety of substrates or surfaces in order to optimize chemical remediation efforts and avoid costly over-treatment.

2. Brief Description of the Prior Art

Biofouling is the gradual accumulation of fluid-borne (typically waterborne) microorganisms (such as, for example, bacteria and protozoa), plants, algae, or animals that are deposited and/or grow on the surfaces of different submerged equipment, pipes, or structures that generally contribute to corrosion and impairment thereof and decrease the efficiency of associated moving parts. Biofouling can occur almost anywhere that water is present and can pose a risk to a variety of different objects, such as, for example, medical devices and membranes, engineering structures, as well as to entire industries, such as food processing, power generation, and other industries that draw upon natural water sources. Generally biofouling, can cause a fluid system to operate outside of its design parameters by decreasing cross-sectional area(s) through which a working fluid flows and decreasing heat transfer properties of the system.

In an industrial setting, biofouling is generally characterized by the attachment of organisms, such as, for example, mussels, oysters, and/or barnacles (macroscopic fouling) or the formation of biofilms (microscopic fouling) on wetted portions of pipe and/or other equipment that receive a supply of water, typically from an external source. Macroscopic and microscopic biofouling can generally increase pipe roughness which, as a result, can restrict flow and increase the power requirement of pumps. Additionally, both macroscopic and microscopic biofouling form a layer on the inner surfaces of a pipe or tube. Such inner layer acts as insulation that decreases heat transfer through said pipe or tube, thereby resulting in decreased heat exchanger performance.

For example, oysters frequently attach themselves to any available substrate, or material often including previously settled organisms. A hard layer, which can comprise a variety of different individual organisms is then formed over said oysters. Such organisms can frequently be removed using an effective chlorine dosing treatment. However, the oyster shells generally remain in place because they are cemented to a substrate and, thus, can only be removed with physical force. Depending on the dimensions of the particular biofouling species and growth patterns, this process frequently results in an irreversible increased wall roughness and reduction of the inner diameter of pipes. Such biofouling can lead to a significant head increase requirement in a fluid system, thereby resulting in relatively higher operational costs and potential operational failures (such as, for example, an unplanned shutdown due to head loss preventing a sufficient amount of water from entering an intake basin).

As a result, there is a need for a system that can provide an operator with the capability of identifying a variety of different substrates and media velocities at which macroscopic and microscopic biofouling can occur.

### SUMMARY OF THE INVENTION

The present invention comprises a biofouling monitor assembly, adapted for use in determining a plurality of flow rates, or media velocities, at which macroscopic and microscopic fouling can occur on a variety of different substrates or materials. By way of illustration, but not limitation, the biofouling monitor assembly of the present invention can simulate a media velocity from static fluid, or water, to approximately 5 feet/second.

The biofouling monitor assembly of the present invention provides system operators the capability to simulate a particular hydraulic industrial system, and thus, identify a variety of different substrates and media velocities at which macroscopic and microscopic biofouling can occur. The data that is received from the biofouling monitor assembly of the present invention can then be used to identify particular locations within a system that present the greatest likelihood for biofouling to occur. This data can then be used to identify optimum biocide dosing locations, concentrations, and regimes which could be applied to prevent biofouling from occurring or to remediate existing biofouling from within a system. A direct relationship between observations and results obtained in the biofouling monitor assembly provide evidence of fouling in all parts of the hydraulic system. Alternatively, the biofouling monitor of the present invention can also demonstrate that no fouling is evident over a particular amount of time, thereby validating an existing dosing regimen or proving that no dosing regimen is necessary. In addition, the present invention may be fitted with a biocide dosing system in order to confirm biocide dosing concentrations and regimes.

The present invention generally comprises an internal monitor assembly that is received within an inner chamber formed within an external enclosure. In a preferred embodiment, the internal monitor assembly is received and fits within said inner chamber that is formed by said external enclosure member; said external enclosure thus defines a housing or casing that can encompass or encapsulate said internal monitor assembly. Said internal monitoring assembly is securely mounted to said external enclosure member using a plurality of standoff plates. Said standoff plates attachably connect said internal monitoring assembly to at least one inner surface of said external enclosure member, thereby firmly holding said internal monitor assembly in position while the present invention is in operation.

Further, a section of tubing, pipe or other conduit, is slidably disposed through an aperture that is positioned near a bottom end of said external enclosure member. Said aperture is axially aligned with an aperture that is positioned near a bottom end of a face plate of said internal monitoring assembly; thus, said section of tubing extends through external enclosure member and into internal monitoring assembly by way of said apertures. As a result, fluid can be washed through the biofouling monitor assembly of the present invention in order to determine, from a range of media velocities within the biofouling monitor assembly, a particular velocity at which macroscopic or microscopic biofouling occurs.

A plurality of coupon inserts are received within the internal monitoring assembly. A first type and a second type of coupon insert are equidistantly spaced apart (thus creating a column or duct between each coupon insert) and are aligned in an alternating configuration. Said first type of coupon insert includes a bore or aperture located near a top end of said coupon insert and attachably connects with a base of said internal monitoring assembly. Said second type of coupon insert does not include a bore and does not connect with the base of said internal monitoring assembly, thereby creating a channel or gap between said insert and said base of the internal monitor assembly.

Additionally, said plurality of coupon inserts are beneficially oriented in a configuration that forms a reduced cross-sectional area along a surface of said coupon inserts. For example, in a preferred embodiment, said coupon inserts comprise a substantially “V” shaped configuration, wherein a top end of the insert has a relatively greater width than a bottom end of the insert. As such, the cross-sectional area of the insert gradually decreases from the top end to the bottom end.

When fluid flows at a similar rate through a smaller cross-sectional area, the velocity of said fluid is relatively faster; when the fluid flows through a greater cross-sectional area, the velocity of the fluid is generally relatively slower. Accordingly, the change in cross-sectional area along the surface of the coupon inserts creates a velocity gradient within the biofouling monitor assembly of the present invention. Moreover, macroscopic fouling or microscopic fouling can occur over a range of different velocity gradients. Thus, a variety of different organisms can settle along said coupon inserts at a variety of different velocity gradients.

As a result, when in operation, a fluid that generally comprises a variety of different macroscopic or microscopic organisms is flushed through said section of tubing. Said fluid enters the internal monitoring assembly at or near its bottom end and flows in a relatively upward direction through a column. The fluid then flows through the bore of the first type of coupon insert, and then flows in a relatively downward direction through another column. Said fluid then flows through the channel that was created by the second type of coupon insert, and then back up through the next column, and so on, until the fluid completes the pathway formed within said internal monitoring assembly and exits the internal monitoring assembly by way of another section of tubing.

An operator is then able to remove each coupon insert from within the internal monitoring assembly in order to determine which organisms attached or settled on said coupon inserts at which locations along said inserts. Such information assists with determining the type of biofouling that can occur within a particular industrial apparatus, pipe, equipment, or any other similar system, depending on the type of velocity and flow rate that passes through that particular system.

In an alternate embodiment, a sleeve attachment can be bonded or bolted to at least one coupon insert. Said sleeve attachment comprises a different material composition or texture from said coupon insert, thereby providing an alternative medium for macroscopic or microscopic biofouling to accumulate. Because different organisms settle and grow on different substrates and at different velocities, such alternative embodiment provides an additional means of testing by providing a parallel system within the biofouling monitor assembly of the present invention.

Further, in an additional alternate embodiment, a heating element can be received on or within at least one coupon insert. Said heating element can be used to simulate a variety of system design temperatures in order to create an environment that is indicative of a particular system that is being monitored. Said heating element comprises a power source and a thermocouple, or temperature logging instrument, that can provide temperature feedback to an operator of the system. Further, said heating element can be used to heat at least one coupon insert or can be used to heat fluid that is flowing within said internal monitoring assembly. As a result, the temperature of the incoming fluid or individual coupon inserts can be adjusted and monitored in order to reproduce a variety of process conditions that are similar to conditions within a system of interest, particularly in order to detect the presence of microfouling.

### BRIEF DESCRIPTION OF THE DRAWINGS/FIGURES

The foregoing summary, as well as any detailed description of the preferred embodiments, is better understood when read in conjunction with the drawings and figures contained herein. For the purpose of illustrating the invention, the drawings and figures show certain preferred embodiments. It is understood, however, that the invention is not limited to the specific methods and devices disclosed in such drawings or figures.

FIG. 1 depicts a perspective view of a preferred embodiment of an external enclosure member of a biofouling monitor assembly of the present invention.

FIG. 2 depicts a side sectional view of a preferred embodiment of an internal monitoring assembly received within an external enclosure member of a biofouling monitor assembly of the present invention.

FIG. 3 depicts an exploded perspective view of a preferred embodiment of an internal monitoring assembly and an external enclosure member of a biofouling monitor assembly of the present invention.

FIG. 4 depicts a perspective view of a preferred embodiment of an internal monitoring assembly of a biofouling monitor assembly of the present invention.

FIG. 5 depicts an aerial view of a preferred embodiment of an internal monitoring assembly of a biofouling monitor assembly of the present invention.

FIG. 6 depicts an exploded perspective view of a preferred embodiment of an internal monitoring assembly of a biofouling monitor assembly of the present invention.

FIG. 7 depicts a front view of a preferred embodiment of a face plate of an internal monitoring assembly of a biofouling monitor assembly of the present invention.

FIG. 8 depicts a front view of a preferred embodiment of a first type of coupon insert of an internal monitoring assembly of a biofouling monitor assembly of the present invention.

FIG. 9 depicts a front view of a preferred embodiment of a second type of coupon insert of an internal monitoring assembly of a biofouling monitor assembly of the present invention.

FIG. 10 depicts a front view of an alternate embodiment of a first type of coupon insert of an internal monitoring assembly of a biofouling monitor assembly of the present invention.

FIG. 11 depicts an overhead view of a preferred embodiment of a base member of an internal monitoring assembly of a biofouling monitor assembly of the present invention.

FIG. 12 depicts a side view of a preferred embodiment of a side member of an internal monitoring assembly of a biofouling monitor assembly of the present invention, illustrating a plurality of coupon inserts received within an internal monitoring assembly.

FIG. 13 depicts a side sectional view of a fluid flow rate velocity profile through a biofouling monitor assembly of the present invention.

FIG. 14 depicts a front sectional view of a fluid flow rate profile along a coupon insert of the present invention.

FIG. 15 depicts an exploded perspective view of a first alternative embodiment of a coupon insert of an internal monitoring assembly having a sleeve attachment.

FIG. 16 depicts an exploded perspective view of a second alternative embodiment of a coupon insert of an internal monitoring assembly having a heating element.

### DETAILED DESCRIPTION OF A PREFERRED EMBODIMENT

Referring to the drawings, the present invention comprises a biofouling monitor assembly 100, adapted for use in determining a plurality of different flow rates at which microscopic fouling occurs on a variety of different materials. By way of illustration, but not limitation, biofouling monitor assembly 100 of the present invention can be manufactured in a variety of different dimensions and can generally be manufactured from a rigid structural material, such as, for example, steel, concrete, plastic, or any other substantially solid material exhibiting like characteristics. Additionally, by way of illustration, but not limitation, biofouling monitor assembly 100 of the present invention can be manufactured by a plurality of manufacturing methods, such as, for example, via a machined plate, a rotational mold, computer numerical control (CNC) milling, blow molding, or any other applicable manufacturing method.

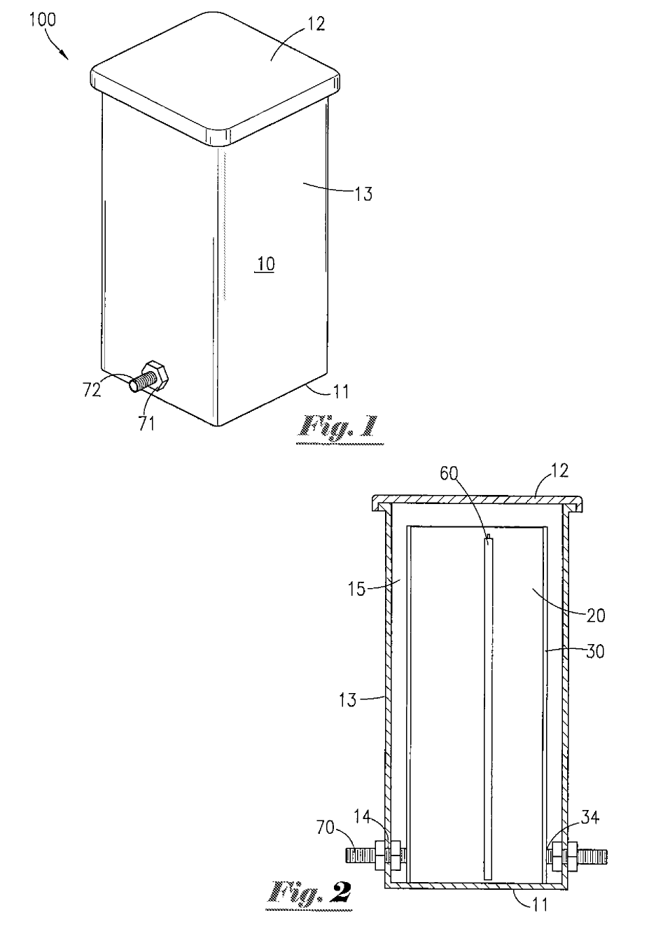

FIG. 1 depicts a perspective view of an external enclosure 10, or shell member, of biofouling monitor assembly 100 of the present invention. External enclosure member 10 generally comprises substantially planar base member 11, substantially planar top or lid member 12, and substantially planar side members 13. Two of said side members 13 are oriented substantially parallel to each other, while the other two of said side members 13 are oriented substantially parallel to each other and substantially perpendicular to the other side members 13. Said base member 11 and top member 12 are oriented substantially parallel to each other, while said side members 13 are substantially perpendicular to base member 11 and top member 12; said base member 11, top member 12, and side member 13 collectively cooperate to form an inner space or chamber 15 for receiving internal monitoring assembly 20.

An aperture 14 is positioned near base member 11 of external enclosure member 10. Circular aperture(s) 14 of external enclosure member 10 extends through side members 13, thereby allowing for a fitting member 72 (such as, for example, a drain or a hose-like attachment) to connect to external enclosure member 10. Fitting member 72 extends through apertures 14 and is connected via a nut(s) 71. Thus, fitting member 72 allows for a fluid to flow through inner chamber 15 of external enclosure member 10 and around internal monitoring assembly 20 of the present invention. Further, fitting member 72 allows for a relatively cylindrical tube 70, or pipe, to be slidably disposed and extend through external enclosure member 10, and ultimately, into internal monitoring assembly 20, thus providing a secure pathway for fluid to flow into and through the present invention. As such, cylindrical tube 70 is coupled to aperture 14 via fitting member 72, or other secure attachment means, thereby providing a secure fluid pressure seal between said tube 70 and said side member 13 and preventing fluid from leaking out of said tube 70 or aperture 14.

FIG. 2 depicts a side sectional view of biofouling monitor assembly 100 of the present invention generally comprising internal monitoring assembly 20 received within and attachably connected to external enclosure member 10. As depicted in FIG. 2, internal monitoring assembly 20 is received and fits within inner chamber 15 of said external enclosure member 10. A plurality of side members 13 (generally two (2)) of external enclosure member 10 include a substantially circular aperture 14 that is positioned near base member 11 of external enclosure member 10. Aperture(s) 14 of external enclosure member 10 axially align with circular apertures 34 of face plate member 30, thereby allowing for a relatively cylindrical tube 70, or pipe, to be slidably disposed through external enclosure member 10 and internal monitoring assembly 20, thus providing a secure pathway for fluid to flow into and through the present invention. As such, although not visible in FIG. 2, cylindrical tube 70 allows for fluid containing organism(s) to flow into biofouling monitor assembly 100 of the present invention, through an inner space of internal monitoring assembly 20, and thus, exit external enclosure member 10, and ultimately, biofouling monitor assembly 100 of the present invention.

As illustrated in FIG. 2, in such configuration, external enclosure member 10 obscures internal monitoring assembly 20 from view, while providing a solid, rigid surface that, along with internal monitoring assembly 20, can cooperate to form a fluid pathway in order to direct a plurality of different organisms (either microorganisms or macroorganisms) in a relatively forward direction, ultimately allowing said organism-filled fluid to exit said enclosure 10, and thus, biofouling monitor assembly 100 of the present invention.

Still referring to FIG. 2, in a preferred embodiment, standoff plate 60 of internal monitoring assembly 20 attachably connects to an inner surface 16 of side member 13 of external enclosure member 10 in a substantially perpendicular configuration. As a result, standoff plates 60 securely position internal monitoring assembly 20 within external enclosure member 10, thereby preventing internal monitoring assembly 20 from sliding and re-positioning within inner chamber 15 of external enclosure member 10 as fluid is flowing through biofouling monitor assembly 100 of the present invention while in operation.

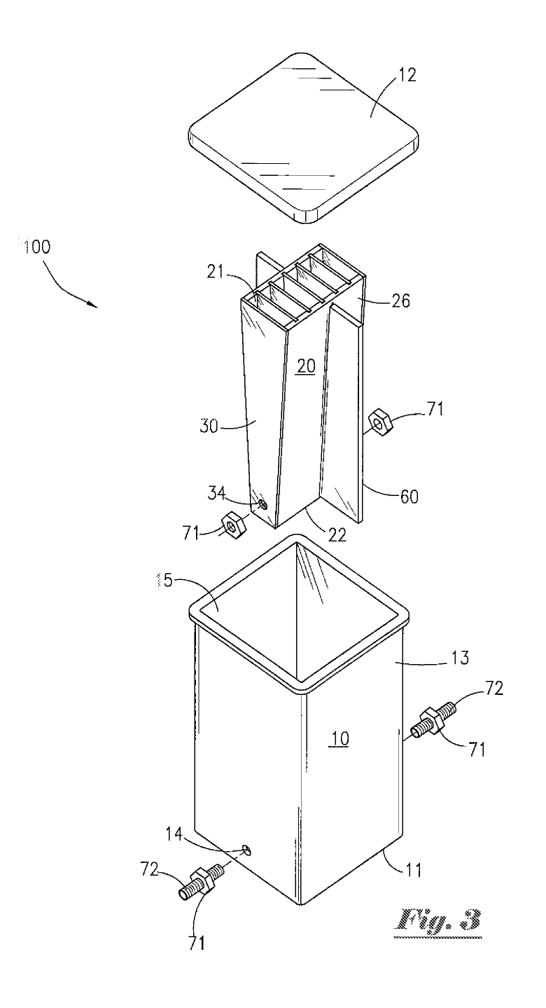

FIG. 3 depicts a perspective view of biofouling monitor assembly 100 of the present invention generally comprising internal monitoring assembly 20 received within inner chamber 15 of external enclosure member 10, wherein said external enclosure member 10 defines a casing or outer shell that can encompass or encapsulate internal monitoring assembly 20. A plurality of side members 13 include aperture 14 that allow for fitting member 72 to provide a secure seal and for tube 70 to be slidably disposed through external enclosure member 10, thus coupling to face plate member 30 of internal monitoring assembly 20. As such, face plate 30 comprises aperture 34 that is axially aligned with aperture 14, thereby allowing for fitting member 72, and ultimately, tube 70, to connect external enclosure member 10 to internal monitoring assembly 20. Further, standoff plates 60 of internal monitoring assembly 20 attachably connect internal monitoring assembly 20 to inner surface 16 of side members 13 of external enclosure member 10. As a result, internal monitoring assembly 20 is securely attached and positioned within external enclosure member 10.

Still referring to FIG. 3, when internal monitoring assembly 20 is received within inner chamber 15 and lid 12 is securely positioned, external enclosure member 10 obscures internal monitoring assembly 20 from view. Lid 12 of external enclosure member 10 can be manufactured from a relatively opaque material, thus preventing a light source from penetrating through external enclosure member 10, and ultimately, preventing said light source from damaging any organisms that are present within biofouling monitor assembly 100.

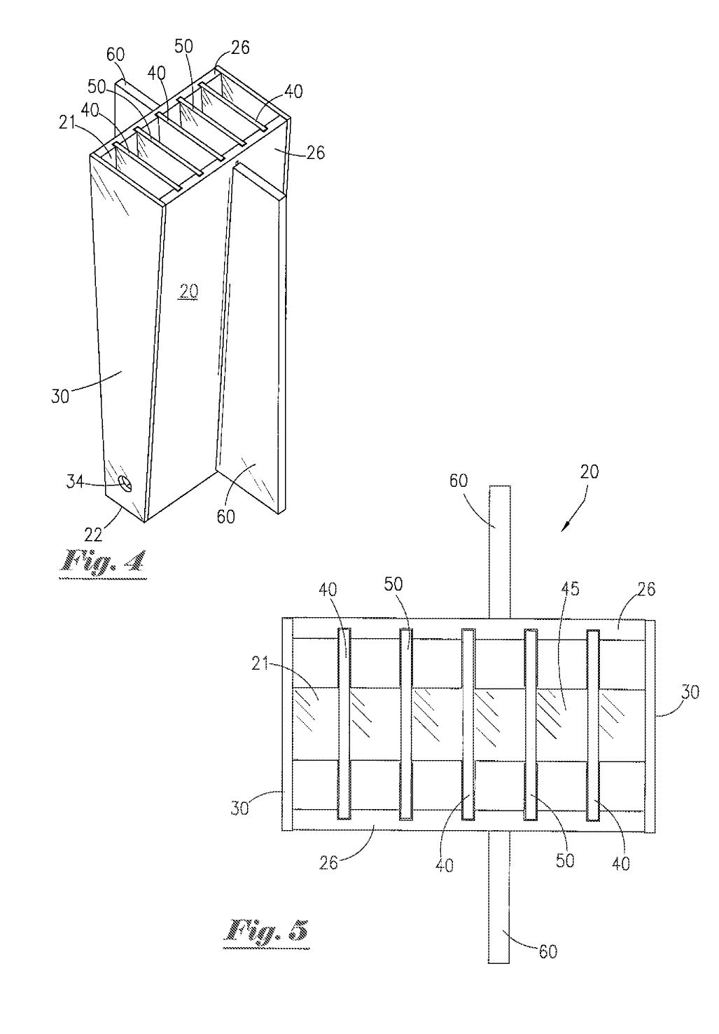

FIG. 4 depicts a perspective view of an internal monitoring assembly 20 of biofouling monitor assembly 100 of the present invention. Internal monitoring assembly 20 generally comprises a substantially planar base member 22, a plurality of substantially planar side members 26, and a plurality of substantially planar face plate members 30. Said side members 26 are oriented substantially parallel to each other, while said face plate members 30 are oriented substantially parallel to each other; said base 22, side members 26 and face plate members 30 beneficially cooperate to form an inner space or chamber 21 within internal monitoring assembly 20.

Still referring to FIG. 4, at least one aperture 34 extends through each of said face plate members 30. Aperture 34 allows for a fitting member to provide a secure seal and a cylindrical tube to be slidably disposed through said face plate members 30, thereby providing a means for fluid to enter inner chamber 21 of internal monitoring assembly 20.

As depicted in FIG. 4, in a preferred embodiment, a plurality of coupon inserts 40 and 50 are generally inserted and received within inner space 21 of internal monitoring assembly 20. Said plurality of coupon inserts 40 and 50 comprise at least two types of coupon inserts (a first type 40 and a second type 50) and can be manufactured from a variety of different materials, including, but not limited to concrete, stainless steel, fibre-glass reinforced plastic (FRP), or polyvinyl chloride (PVC). Coupon inserts 40 and 50 are oriented substantially parallel to face plate members 30, and substantially perpendicular to side members 26 of internal monitoring assembly 20. Further, coupon inserts 40 and 50 are equidistantly spaced apart within inner space 21 of internal monitoring assembly 20, wherein first type 40 and second type 50 of coupon inserts are aligned and oriented in an alternating configuration.

Still referring to FIG. 4, in a preferred embodiment, internal monitoring assembly 20 generally comprises a plurality of substantially planar standoff plates 60. Said standoff plates 60 attachably connect to side members 26 in a substantially perpendicular orientation, thereby extending in a relatively outward direction from side members 26 of internal monitoring assembly 20.

FIG. 5 depicts an aerial view of internal monitoring assembly 20 of the present invention generally comprising a plurality of coupon inserts 40 and 50. As depicted in FIG. 5, base member 22, side members 26, and face plate members 30 collectively cooperate to form inner chamber 21 of internal monitoring assembly 20. Further, coupon inserts 40 and 50 are received within inner chamber 21 of internal monitoring assembly 20 and are positioned in a substantially parallel configuration to face plate members 30. Coupon inserts 40 and 50 are substantially equidistantly spaced apart, thereby forming an inner column 45, or duct, between each coupon insert 40 and 50. In addition, standoff plates 60 are positioned relatively perpendicular to side members 26, thus providing a means of stability for internal monitoring assembly 20.

FIG. 6 depicts an exploded perspective view of internal monitoring assembly 20 of the present invention. Internal monitoring assembly 20 comprises base member 22, side members 26, and face plate members 30 that collectively cooperate to form inner chamber 21. Face plate members 30 each comprise aperture 34, whereby a section of tubing or piping can be slidably disposed through aperture 34, thus allowing for a means by which fluid can enter and exit internal monitoring assembly 20. Side members each comprise a plurality of slots, or grooves 49 and 59 that allow for coupon inserts 40 and 50 to be received within inner chamber 21, and thus, securely positioned in place. As such, coupon inserts 40 and 50 are received within inner chamber 21, thereby creating columns 45, or ducts, in between each coupon insert 40 and 50. Further, internal monitoring assembly 20 comprises standoff plates 60 that perpendicularly connect to side members 26 and an inner surface of external enclosure member 10, thus securely holding internal monitoring assembly 20 in place during operation.

As depicted in FIG. 6, first type of coupon insert 40 comprises a substantially circular bore 44 located near a top end 41 of coupon insert 40. As such, circular bore 44 creates an orifice for fluid to flow through as a pathway to the next column or duct as said fluid flows through internal monitoring assembly 20. Additionally, although not depicted in FIG. 6, first type of coupon insert can comprise a bore having a different or alternative configuration, such as, for example, an oblong configuration, without departing from the scope of the present invention. As a result, the shape and size of said bore can dictate a rate of fluid flow throughout internal monitoring assembly 20, thereby determining the type and density of organism(s) that settle onto coupon inserts 40 and 50.

Still referring to FIG. 6, second type of coupon insert 50 comprises a substantially solid, rigid surface that does not include a bore or aperture (such as, for example, bore 44 of coupon 40). Further, first type of coupon insert 40 and second type of coupon insert 50 can be beneficially aligned in an alternating configuration within inner chamber 21 of internal monitoring assembly 20, and are thus equidistantly spaced apart within said inner chamber 21, thereby creating a plurality of internal columns 45 formed between each coupon insert 40 and 50.

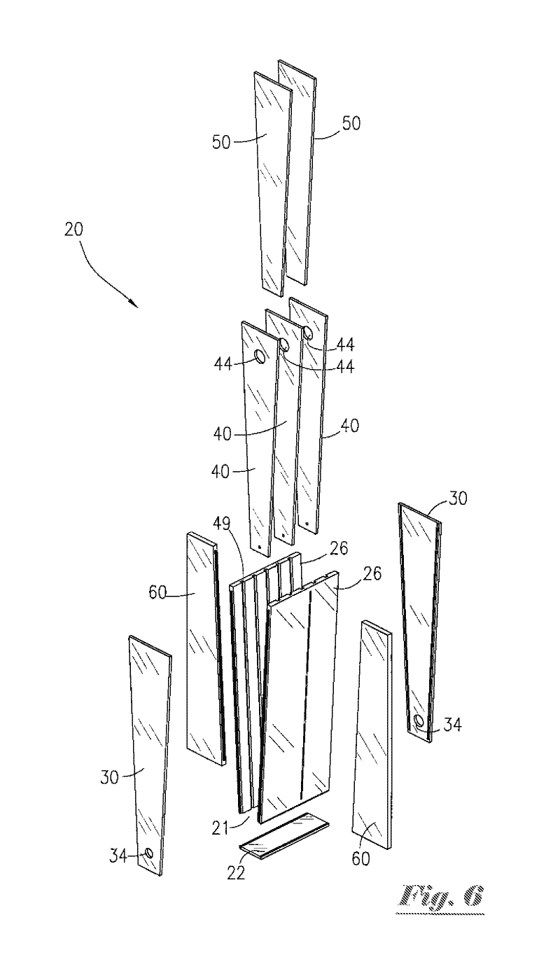

FIG. 7 depicts a side view of a face plate member 30 of internal monitoring assembly 20 of the present invention. Face plate member 30 generally comprises a substantially planar surface, having a top end 31, a bottom end 32, and a plurality of side ends 33. Said top end 31 has a relatively greater width than said bottom end 32, thereby creating relatively inwardly or tapered sloped side ends 33, thus forming a substantially “V” shaped configuration. Said “V” shape of face plate member 30 provides a reduced cross-sectional area from top end 31 to bottom end 32 as said width gradually decreases, thereby creating a fluid velocity gradient as fluid flows along each plate 30 within internal monitoring assembly 20 of biofouling monitor assembly 100 of the present invention. However, by way of illustration, but not limitation, face plate member 30 can comprise a variety of different shapes or configurations that ultimately reduce the cross-sectional area of plate member 30.

Further, still referring to FIG. 7, face plate member 30 includes a relatively circular aperture 34 that is positioned near bottom end 32 of and extends through, each face plate 30, thus allowing for a section of tubing to be slidably disposed through said face plate members 30, thereby providing a means for fluid to enter and exit inner chamber of internal monitoring assembly 20.

FIG. 8 depicts a side view of a first type of coupon insert 40 of internal monitoring assembly 20 of the present invention. First type of coupon insert 40 generally comprises a substantially planar surface, having a top end 41, a bottom end 42, and a plurality of side ends 43. Said top end 41 has a relatively greater width than said bottom end 42, thereby creating relatively inwardly sloped or tapered sides 43, thus forming a substantially “V” shaped configuration. Said “V” shape of first type of coupon insert 40 provides a reduced cross-sectional area from top end 41 to bottom end 42 as the width gradually decreases, thereby creating a fluid velocity gradient as fluid flows along each insert 40 within biofouling monitor assembly 100 of the present invention. However, by way of illustration, but not limitation, first type of coupon insert 40 can comprise a variety of different shapes or configurations that ultimately reduce the cross-sectional area of said coupon insert.

Additionally, still referring to FIG. 8, first type of coupon insert 40 includes a substantially circular bore 44 that is positioned near a top end 41 of, and extends through, said insert 40. Circular bore 44 allows for fluid to flow through first type of coupon insert 40, thereby continuing a fluid pathway along a duct between a second type of coupon insert 50 of internal monitoring assembly 20. Circular bore 44 can be configured in a variety of different dimensions, wherein a particular size of said bore 44 can dictate an amount of fluid that can flow into and through internal monitoring assembly 20. As such, bore 44 can have a variety of different sizes and/or configurations depending on a particular flow rate that is needed during a specific simulated operation.

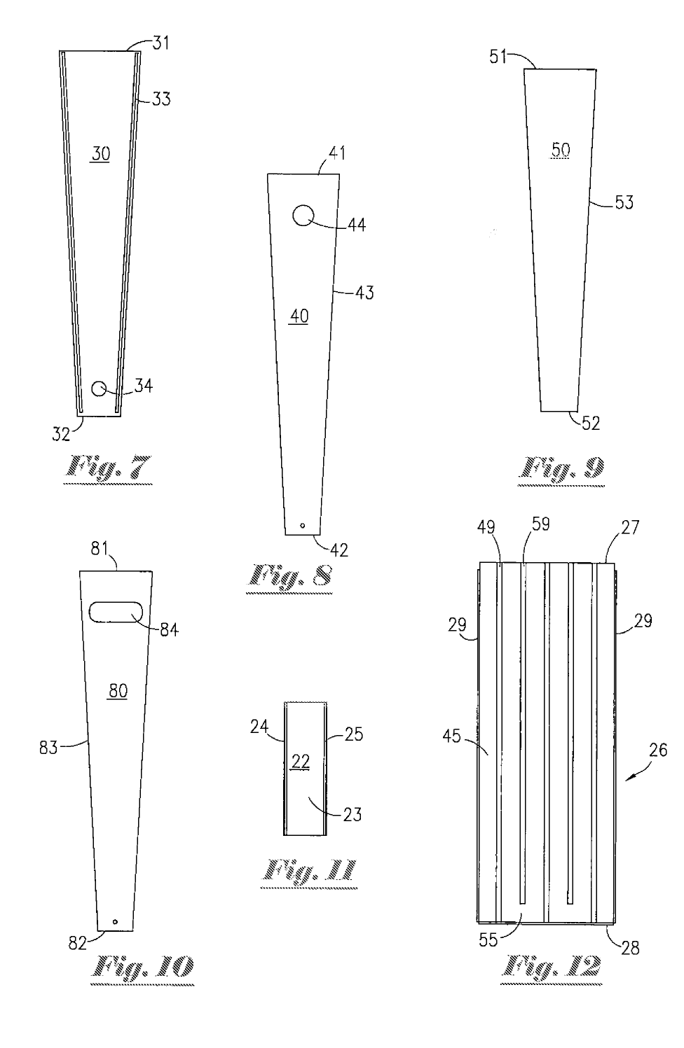

FIG. 9 depicts a side view of a second type of coupon insert 50 of internal monitoring assembly 20. Said second type of coupon insert 50 generally comprises a substantially planar surface, having a top end 51, a bottom end 52, and a plurality of side ends 53. Said top end 51 has a relatively greater width than said bottom end 52, thereby creating relatively inwardly sloped or tapered side ends 53, thus forming a substantially “V” shaped configuration. Said “V” shape of second type of coupon insert 50 provides a reduced cross-sectional area from top end 51 to bottom end 52 as the width gradually decreases, thereby creating a fluid velocity gradient as fluid flows along each insert 50 within biofouling monitor assembly 100 of the present invention. However, by way of illustration, but not limitation, second type of coupon insert 50 can comprise a variety of different shapes or configurations that ultimately reduce the cross-sectional area of said coupon inserts 50.

FIG. 10 depicts a side view of an alternate embodiment of a first type of coupon insert 80 of the present invention. First type of coupon insert 80 includes bore 84 located near a top end 81 of, and extending through, said coupon insert 80. As such, bore 84 creates an orifice for fluid to flow through as said fluid is progressing through internal monitoring assembly 20. As depicted in FIG. 10, first type of coupon insert 80 includes a bore 84 having a different configuration, such as, for example, a substantially oblong configuration. Bore 84 can be configured in a variety of different dimensions or shapes, wherein a different size and/or shape of bore 84 can affect a flow rate or an amount of fluid that can flow into and throughout internal monitoring assembly 20, thereby ultimately determining the type and amount of organism(s) that can settle onto coupon inserts 80. As such, bore 84 can have a variety of particular sizes and/or shapes depending on a particular flow rate that is needed during a specific simulated operation.

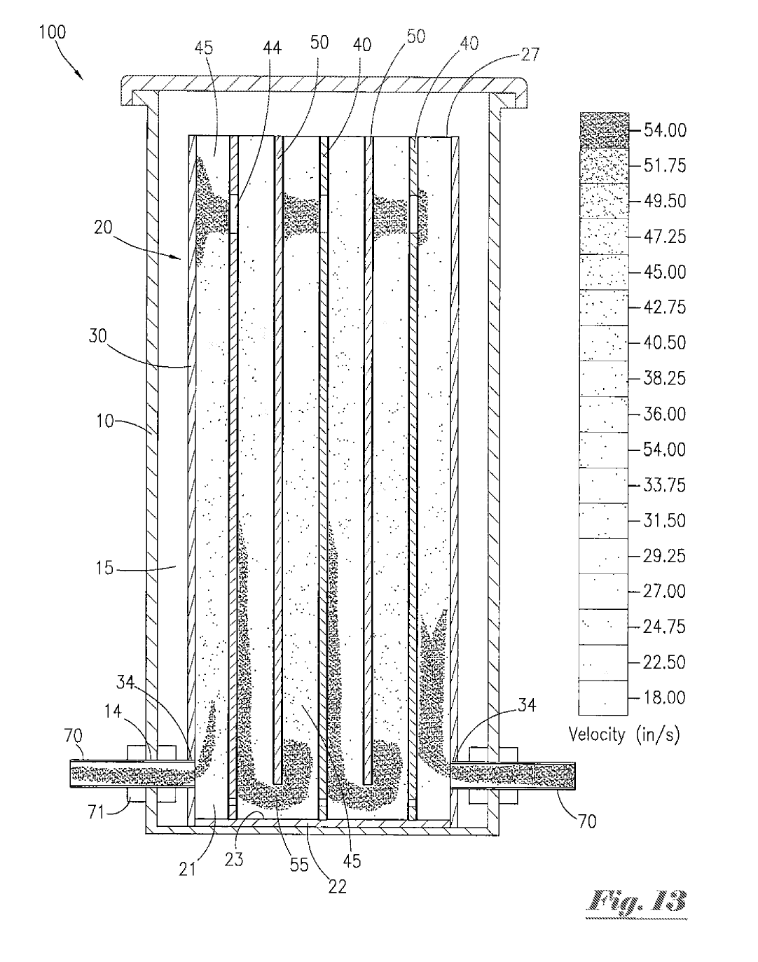

FIG. 11 depicts an overhead or aerial view of a base member 22 of internal monitoring assembly 20 of the present invention. Base member 22 generally comprises a substantially planar surface, having a top surface 23, a bottom surface 24, and a plurality of sides 25. Base member 22 beneficially provides a surface in which side members 26 and face plate members 30 can be attachably mounted. As such, base member 22 beneficially cooperates with side members 26 and face plate members 30 to form an inner chamber within internal monitoring assembly 20, thus retaining fluid within internal monitoring assembly 20 of the present invention while in operation.

FIG. 12 depicts a side view of side member 26 of internal monitoring assembly 20 of the present invention illustrating an internal alignment of grooves 49 and 59. Side members 26 generally comprise a substantially planar surface, having a top end 27, a bottom end 28, and a plurality of side ends 29. Side members 26 are positioned substantially parallel to each other and are positioned in a substantially perpendicular configuration to face plate members 30. Further, side members 26 include a plurality of grooves 49 and 59 that extend vertically along an inner surface of side members 26. Grooves 49 and 59 allow for coupon inserts 40 and 50 to be securely positioned within inner chamber 21 of internal monitoring assembly 20, thereby creating columns 45 between each groove 49 and 59.

Still referring to FIG. 12, groove 49 (that receives coupon insert 40) fully extends in a relatively vertical direction from top end 27 to bottom end 28 of side member 26, thereby attachably connecting with base member 22 of internal monitoring assembly 20. However, groove 59 (that receives coupon insert 50) extends in a relatively vertical direction from top end 27 of side member 26 but does not fully extend to bottom end 28 of side member 26 or connect to base member 22 of internal monitoring assembly 20, thereby creating a gap or channel 55 for fluid to flow between bottom end 52 of coupon insert 50 and upper surface 23 of base member 22 in order to continue the pathway to another column 45.

As a result, although not visible in FIG. 12, when a fluid that comprises microscopic fouling organisms is pumped or otherwise flows through biofouling monitor assembly 100 of the present invention, said fluid will travel in a pathway that flows down column 45, through channel 55 that is formed via second type of coupon insert 50 and base member 22, and back up internal column 45 that is formed in between each groove 49 and 59, and thus, coupon inserts 40 and 50. This fluid pathway is continued until fluid is able to exit internal monitoring assembly 20.

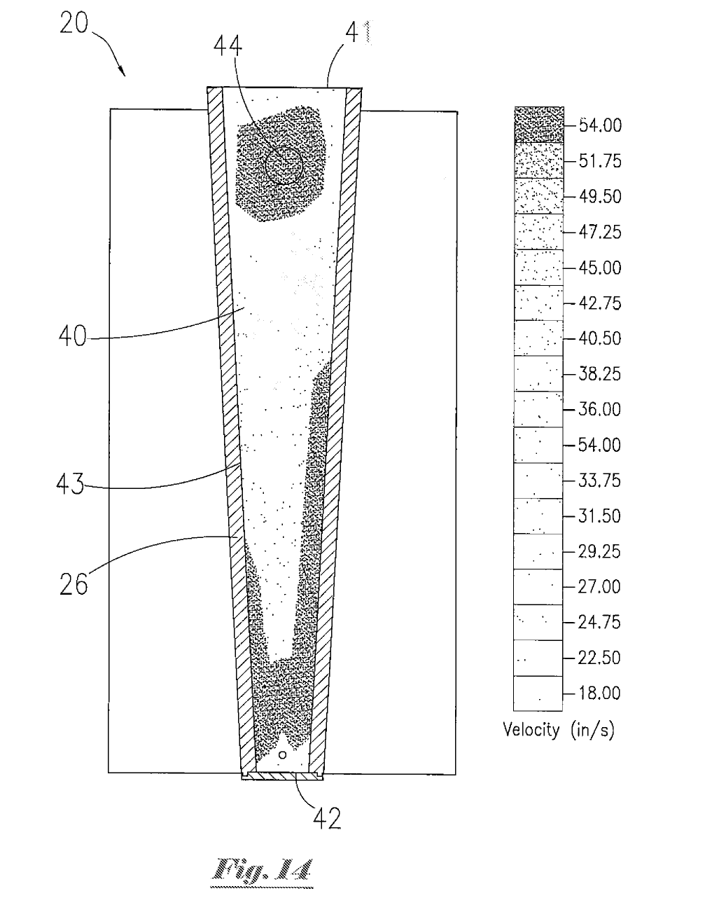

FIG. 13 depicts a side cross-sectional view of an internal fluid flow velocity gradient of a representative fluid flowing through biofouling monitor assembly 100 of the present invention. First type of coupon insert 40 fully extends in a relatively vertical direction from top end 27 to bottom end 28 of side member 26, thereby attachably connecting with base member 22 of internal monitoring assembly 20. However, second type of coupon insert 50 extends in a relatively vertical direction from top end 27 of side member 26 but does not fully extend to bottom end 28 of side member 26 or connect to base member 22 of internal monitoring assembly 20, thus creating a gap or channel 55 for fluid to flow between bottom end 52 of coupon insert 50 and upper surface 23 of base member 22 in order to continue the pathway to another column 45.

As illustrated in FIG. 13, in a preferred embodiment, fluid containing at least one organism is pumped or otherwise flows through cylindrical tube 70, thereby entering external enclosure member 10 through aperture 14 and flows through internal monitoring assembly 20 through aperture 34 of face plate 30. Said fluid then travels along a pathway through inner chamber 21 of internal monitoring assembly 20. Said pathway is formed via fluid flowing in a relatively upward direction through column 45, through bore 44, in a relatively downward direction through column 45, and then through inner channel 55 that is formed between first type coupon insert 40 and second type coupon insert 50, and so on. Eventually, after traveling through inner columns 45 and inner channels 55, said fluid is then able to exit internal monitoring assembly 20, and thus, external enclosure member 10, via cylindrical tube 70.

As depicted in FIG. 13, fluid containing at least one organism enters inner chamber 21 of internal monitoring assembly 20 at a relatively higher rate and higher flow velocity. The flow velocity of said fluid gradually decreases said fluid flows in a relatively upward direction through column 45. Said fluid then flows through bore 44 of first coupon insert 40; the fluid velocity then increases as said fluid flows in a relatively downward direction through next column 45.

In a preferred embodiment, the fluid flow velocity gradient throughout inner chamber 21 of internal monitoring assembly 20 is created as a result of the configuration of said coupon inserts 40 and 50. By having a reduced cross-sectional area at a bottom end 42 and 52 of each coupon insert 40 and 50, respectively, said fluid flow velocity gradient is relatively faster when said fluid flows over said reduced cross-sectional area. As the cross-sectional area of the coupon inserts 40 and 50 gradually increases, said fluid flow velocity gradient decreases due to the fluid flowing over a relatively larger coupon surface Different organisms can generally settle and attach to substrates at different fluid velocities; thus, the change in the velocity gradient throughout the internal monitoring assembly 20 allows an operator to test and view which organism(s) settle at which particular locations, and thus, at which particular fluid flow velocities. Such information is then able to assist an operator in determining which organisms are generally settling and accumulating in a particular industrial plant, pipe, equipment, or any other field that is being tested or modeled.

Although not depicted in FIG. 13, prior to running the testing operation, a particular location that is parallel to a portion of a system component or a system of interest is first identified. It is necessary that the water quality parameters of said fluid or water flowing through biofouling monitor assembly 100 is generally indicative of said system of interest. Testing commences by opening an inlet valve on cylindrical tubing 70, thereby allowing said fluid supply to flow through biofouling monitor assembly 100. Said valve is then trimmed to ensure that a level fluid, or water, height is achieved in inner chamber 21 of internal monitoring assembly 20. Testing continues indefinitely with coupon inserts 40 and 50 being either inspected by an operator, who physically removes and inspects each plate, or inspected remotely via a camera and/or light assembly that can be mounted within inner chamber 15 of external enclosure 10.

When coupon inserts 40 and 50 are manually inspected, said operator removes lid 12 from external enclosure member 10. Each coupon insert 40 and 50 are slidably removed from internal monitoring assembly 20. Any organism(s) that have settled on coupons 40 and 50 are then documented, and said coupons 40 and 50 are then slidably re-inserted into internal monitoring assembly 20. This is generally performed at an interval that is characteristic of the organism(s) that is being studied (such as, for example, daily, weekly, or monthly). Said coupon inserts 40 and 50 can be weighed at the start of the test and then weighed at each inspection in order to determine a rate of accumulation of biomass. Alternatively, internal monitoring assembly 20 can be placed on a scale, wherein the weight is recorded immediately after the test has started and then again at a later interval.

Removing coupon inserts 40 and 50 allows an operator to inspect said coupon inserts and collect data in order to detect quality and quantity of biofouling that has occurred throughout biofouling monitor assembly 100 of the present invention and across different positions and locations along coupon inserts 40 and 50. Thus, removing coupon inserts 40 and 50 allows an operator to determine which organism(s) can generally settle and/or propagate on various different materials at a particular fluid velocity. As a result, the type of organism, rate of settlement, rate of growth, and location on coupon inserts 40 and 50 that each individual organism settles is then used to pinpoint where biofouling occurs within the system of interest.

FIG. 14 depicts a front sectional view of an internal fluid flow velocity gradient along coupon insert 40 of the present invention. In a preferred embodiment, said velocity gradient along coupon insert 40 is relatively greater toward the bottom end 42 of coupon insert 40, and said fluid velocity gradient gradually decreases toward top end 41 of coupon insert 40. By having a relatively shorter width, and thus a relatively smaller cross-sectional area, the velocity of the fluid is relatively faster near the bottom end 42 of coupon insert 40. As the width of said coupon insert 40 gradually increases, and thus, has a relatively larger cross-sectional area, the fluid flow velocity gradually decreases. As a result, fluid flowing at or near top end of 41 coupon insert 40 has a relatively slower velocity than at or near bottom end 42 of coupon insert 40.

As illustrated in FIG. 14, the fluid flow velocity gradient along the length of coupon insert 40 increases as fluid then passes through bore 44, and then as the cross-sectional area of coupon insert 40 gradually decreases. Thus, a gradual change in fluid flow velocity gradient continues throughout the inner chamber 21 of internal monitoring assembly 20 as fluid containing organism(s) is pumped or otherwise flows through biofouling monitor assembly 100 of the present invention.

FIG. 15 depicts an exploded perspective view of an alternate embodiment of coupon insert 40 of internal monitoring assembly 20. In an alternate embodiment, coupon insert 40 comprises a sleeve attachment 65 that can be bonded or bolted to coupon insert 40. Sleeve 65 comprises a top end 66, a bottom end 67, and a plurality of sides 68 that are oriented in the same basic configuration as coupon insert 40, generally a “V” shaped configuration. Further, sleeve attachment 65 includes a bore 69 that is located in a same position as bore 44, thus preventing any obstruction or restriction of fluid flow through internal monitoring assembly 20.

Sleeve 65 can be manufactured in a variety of different materials and textures, thereby providing a different substrate upon which organisms can grow and settle, and thus, upon which biofouling can occur. Because organisms can settle and grow on a variety of different material compositions and textures, sleeve attachment 65 can be affixed to coupon insert 40 in order to simulate a variety of different systems or industrial scenarios within internal monitoring assembly 20, and thus, can test and monitor biofouling along different material compositions and textures.

Further, although not illustrated in FIG. 15, sleeve attachment 65 can also be bonded to second type of coupon insert 50, to all of the coupon inserts 40 and 50, or to a select number of coupon inserts 40 and 50. The number of sleeve attachments 65 that can be used within internal monitoring assembly 20 can depend on the number of different materials that are to be tested during a particular test run.

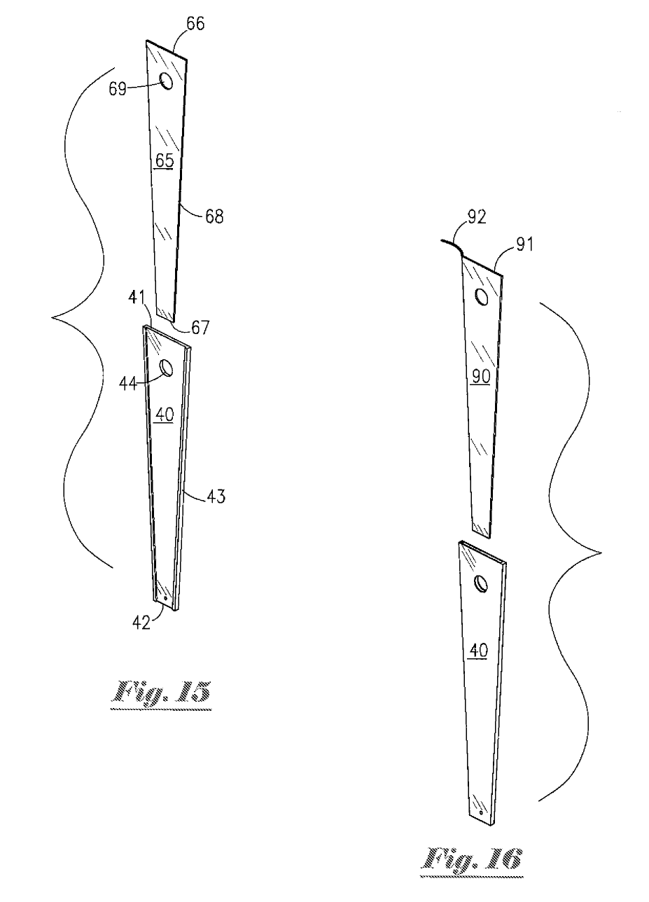

FIG. 16 depicts an exploded perspective view of an additional alternate embodiment of coupon insert 40. In an additional alternate embodiment, coupon insert 40 comprises a heating element 90 in order to simulate a plurality of system design temperatures, thereby creating an environment that is indicative of a particular system that is being simulated, monitored or tested. Heating element 90 comprises a thermocouple 91, or a temperature sensor and/or logging monitor, that is used to provide temperature measurements to an operator and permit recordation thereof. Further, heating element 90 comprises a relatively thin, rod-like probe that provides a power source 92 for heating element 90.

Still referring to FIG. 16, when heating element 90 is received within coupon insert 40, said heating element 90 is capable of supplying heat to a surface of coupon insert 40 in order to simulate a heat exchanger temperature. As a result, when power source 92 is actuated and heating element 90 is able to change temperature, heating element 90 can raise a temperature of coupon insert 40 and, thus, surrounding fluid, within internal monitoring assembly 20. Additionally, although not depicted in FIG. 16, heating element 90 can also be used to adjust temperature of fluid within internal monitoring assembly 20 where configured as submersible heater(s).

As a result, the temperature of incoming fluid, and the temperature of coupon inserts 40 and 50 can be adjusted and monitored in order to reproduce a variety of process conditions in order to monitor said environment conditions that are similar to those within a particular system of interest (that is, a system being modeled or tested) and in order to provide a more beneficial means of detecting microfouling.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

1. A method for testing bio-fouling characteristics of a fluid containing at least one organism comprising:
a) introducing said fluid into a bio-fouling test assembly, wherein said bio-fouling test assembly comprises:
(i) an external enclosure defining an inner chamber, a fluid inlet extending into said chamber and a fluid outlet extending out of said chamber;
(ii) a plurality of coupons disposed within said chamber, wherein said coupons define a fluid flow path extending around said coupons from said inlet to said outlet; and
b) circulating said fluid through said fluid flow path, wherein said fluid flows across each of said coupons at a plurality of different flow velocities.

2. The method of claim 1, wherein said coupons are removeably disposed within said chamber.

3. The method of claim 1, wherein said at least one organism is deposited along a surface of at least one of said coupons.

4. The method of claim 3, further comprising the step of measuring an amount of said at least one organism deposited on said at least one coupon.

5. The method of claim 4, further comprising the step of measuring a rate of accumulation of said at least one organism on said at least one coupon.

6. The method of claim 5, further comprising the step of correlating at least one rate of accumulation of said at least one organism on said at least one coupon to at least one flow velocity.

7. The method of claim 4, further comprising the step of plotting rates of accumulation of said at least one organism against measured flow velocities.

8. The method of claim 1, wherein each of said coupons comprises a top, a bottom and two sides.

9. The method of claim 8, wherein each of said coupons define a larger surface area at said top than at said bottom.

10. The method of claim 1, further comprising the step of heating at least one of said coupons or said fluid.

11. A bio-fouling test assembly comprising:
a) an external housing defining a chamber, a fluid inlet extending into said chamber and a fluid outlet extending out of said chamber; and
b) a plurality of coupons disposed within said chamber, wherein said coupons define a fluid flow path extending around said coupons from said inlet to said outlet.

12. The bio-fouling test assembly of claim 11, further comprising an internal enclosure defining an inner compartment, a fluid inlet extending into said inner compartment and a fluid outlet extending out of said inner compartment, wherein said internal enclosure is disposed within said inner chamber of said external housing.

13. The bio-fouling test assembly of claim 12, wherein said fluid inlet of said external housing is operationally connected to said fluid inlet of said internal enclosure.

14. The bio-fouling test assembly of claim 12, wherein said fluid outlet of said external housing is operationally connected to said fluid outlet of said internal enclosure.

15. The bio-fouling test assembly of claim 11, wherein said flow path has a length, fluid flowing through said flow path travels at different velocities along the length of said path.

16. The bio-fouling test assembly of claim 11, wherein each of said coupons comprises a top, a bottom and two sides.

17. The bio-fouling test assembly of claim 16, wherein each of said coupons define a larger surface area at said top than at said bottom.

18. The bio-fouling test assembly of claim 11, further comprising a sleeve attachment bonded to an outer surface of said coupons.

19. The bio-fouling test assembly of claim 11, further comprising at least one heating element operationally attached to at least one of said coupons.

20. The bio-fouling test assembly of claim 19, wherein said at least one heating element is adapted to raise a temperature of at least one of said coupons or a fluid flowing through said fluid flow path.
